(19) United States
(12) Patent Application Publication
(10) Pub. No.: US 2005/0205401 A1
(43) Pub. Date: Sep. 22, 2005

(54) Silver contact fixing structure for conductive blades

(76) Inventor: Chin-Wen Chou, Taipei Hsien (TW)

Correspondence Address: BIRCH STEWART KOLASCH & BIRCH, PO BOX 747, FALLS CHURCH, VA, 22040-0747, US

(21) Appl. No.: 10/802,748

(22) Filed: Mar. 18, 2004

(51) Int. Cl. G03C 1/06

(52) U.S. Cl. 200/283

(57) ABSTRACT

A silver contact fixing structure for conductive blades aims at providing a retaining force on a silver contact so that the silver contact is more secure and does not break loose when subject to striking. The silver contact is built in a fastening section formed on a conductive blade. The fastening section has at least two fixing zones connecting to each other and a bucking end adjacent to the fixing zones to increase the retaining force between the silver contact and the conductive blade so that the silver contact does not break loose easily thereby increasing the service life thereof.

### FIELD OF THE INVENTION

The present invention relates to a silver contact fixing structure for conductive blades and particularly to a technique that employs a novel conductive blade structure and a silver contact fixing method to enhance the strength of silver contacts.

### BACKGROUND OF THE INVENTION

Conventional techniques for fabricating silver contacts often encounter some problems, notably:

Silver contacts are usually used in switches to establish conductive connection. When in use, the silver contact receives a strike from a connection leg to form a connection contact with the switch. The conventional silver contact is generally wedged in a housing space. When subject to striking over a prolonged period, the silver contact is prone to break loose from the conductive blade.

To remedy the foregoing problem, a technique has been disclosed to improve the fabrication of silver contacts in R.O.C. patent publication No. 448454 entitled “Method for fastening silver contacts of conductive blades”. It punches a fastening hole on a conductive blade that is concave on the upper side and convex on the lower side. Extra material of the conductive blade is extruded to form an extended wedging flange. The fastening hole has screw threads formed therein to provide a horizontal friction force so that the silver contact is less likely to break off. Finally, the top section of the silver wire is formed in a protrusive bucking flange through an upper mold, and a lower mold is deployed to ram the wedging flange towards the fastening hole so that the silver wire is filled and wedged securely in the fastening hole. The aforesaid technique can fix the silver contact more securely without breaking loose. However, in the design of switches, the interval between the movable contact and the closed circuit contact has to comply with safety regulations (for instance the interval under European safety regulations is 3 mm). The protrusive bucking flange will affect the distance between the movable contact and the closed circuit contact. Hence, the relative positions of the elements in the switch have to be rearranged.

Referring to FIG. 1, to resolve the problems set forth above, some people proposed an injection forming approach to embed the silver contact when the conductive blade is formed by injection. Such a design does not create the bucking flange, and the positions of the elements in the switch do not need to be rearranged. However, embedding by injection forming requires fabrication of new molds to suit the different contact sizes of various switches. Manufacturing processes cannot be modularized. As a result, manufacturing cost is higher.

### SUMMARY OF THE INVENTION

The primary object of the invention is to solve the aforesaid problems. The invention provides a method and structure for fixing silver contacts more securely. The conductive blade has a fastening section corresponding to where a silver contact is located. The fastening section has at least two fixing zones formed on a corresponding vertical surface connected to each other, and a bucking end abutting the juncture of the fixing zones so that a silver wire may be pressed and filled in the fastening section to form the silver contact. Thus, a retaining force is provided when the connection leg strikes the silver contact. Moreover, the horizontal cross section of the fastening section may be formed in a non-circular and irregular shape to make the silver contact less likely to break loose.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a cross section of a conventional silver contact.

FIG. 2 is a perspective view of a first embodiment of the conductive blade of the present invention.

FIGS. 3A through 3F are schematic views of the fabrication process of the first embodiment of the invention.

FIG. 4 is a perspective view of a second embodiment of the conductive blade of the present invention.

FIG. 5 is a top view of the second embodiment of the present invention.

FIGS. 6A through 6F are schematic views of the fabrication process of the second embodiment of the invention.

FIG. 7 is a cross section of a third embodiment of the present invention.

FIG. 8 is a cross section of a fourth embodiment of the present invention.

FIGS. 9A, 9B and 9C are cross sections of a fifth embodiment of the present invention.

FIG. 10 is a cross section of a sixth embodiment of the present invention.

FIG. 11 is a cross section of a seventh embodiment of the present invention.

FIG. 12 is a cross section of an eighth embodiment of the present invention.

FIG. 13 is a block diagram of the fabrication process for the first embodiment through to the eighth embodiment of the invention.

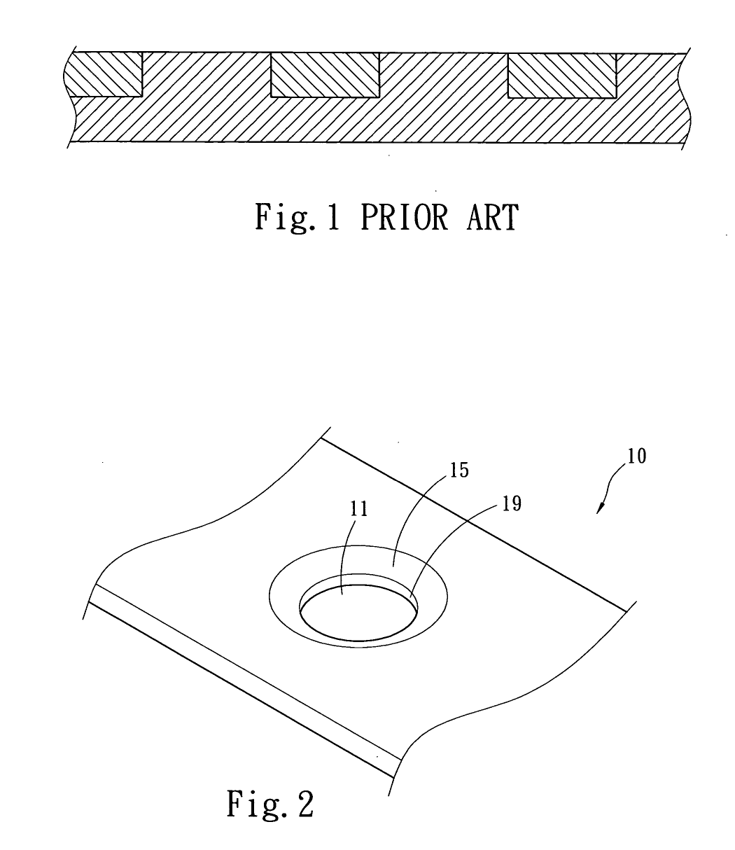

### DETAILED DESCRIPTION OF THE PREFERRED EMBODIMENTS

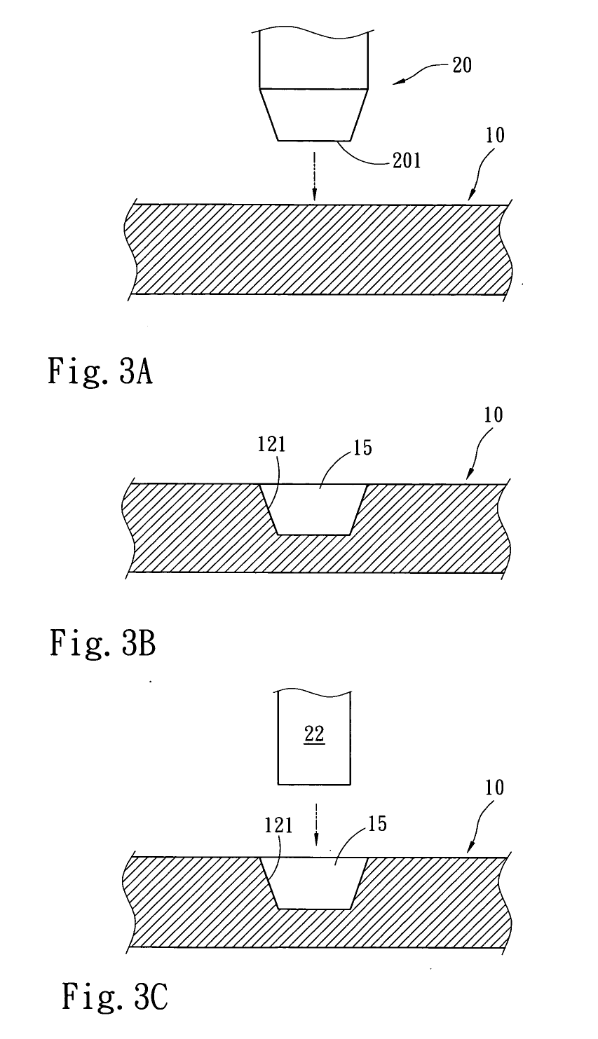

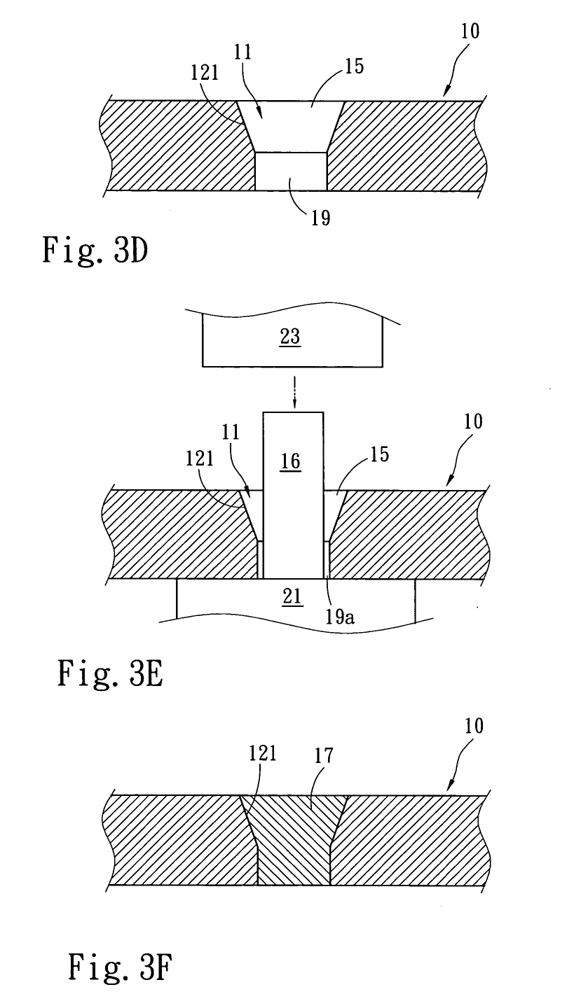

Please refer to FIGS. 2, 3-A through 3-F, and 13 for a conductive blade 10 of a first embodiment of the invention. It has a fastening section 11 corresponding to where a silver contact 17 is located. The fastening section 11 has a first fixing zone 15 and a second fixing zone 19 on a vertical surface corresponding to the conductive blade 10 that connects to each other. The first fixing zone 15 is greater than the second fixing zone 19 and forms a bucking end 121 at their juncture. A silver wire 16 is pressed and filled in the fastening section 11 to form a silver contact 17, which has the same shape as the fastening section 11. The bucking end 121 provides a retaining function to increase the retaining strength. Fabrication of the conductive blade 10 includes the following steps in the order of A: stamping a blank; B: stamping the blank for a second time; and C: planting the silver wire.

Step A: stamping a blank. Form the first fixing zone 15 on the conductive blade 10 by stamping through a punching end 201 of a first upper mold 20. The punching end 201 is a cylinder with a lower tapered end. The first fixing zone 15 has a bucking end 51 formed on the peripheral side of one end thereof in a chamfered angle.

Step B: stamping the blank for a second time. Form the second fixing zone 19 on the conductive blade 10 by stamping through a second upper mold 22. The first fixing zone 15 is bigger than the second fixing zone 19. The bucking end 121 is located on the peripheral side of one end of the first fixing zone 15 in a chamfered angle.

Step C: planting the silver wire. Place the conductive blade 10 on a first lower mold 21; press and fill the silver wire 16 in the fastening section 11 to become the silver contact 17 which has the same shape of the fastening section 11. The bucking end 121 strengthens the retaining ability.

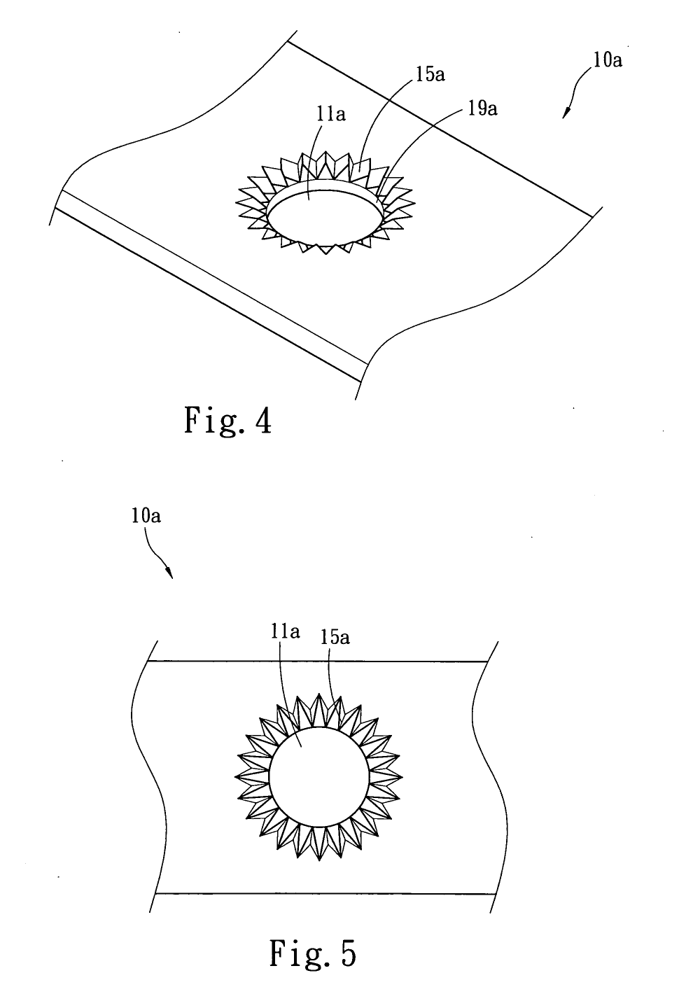

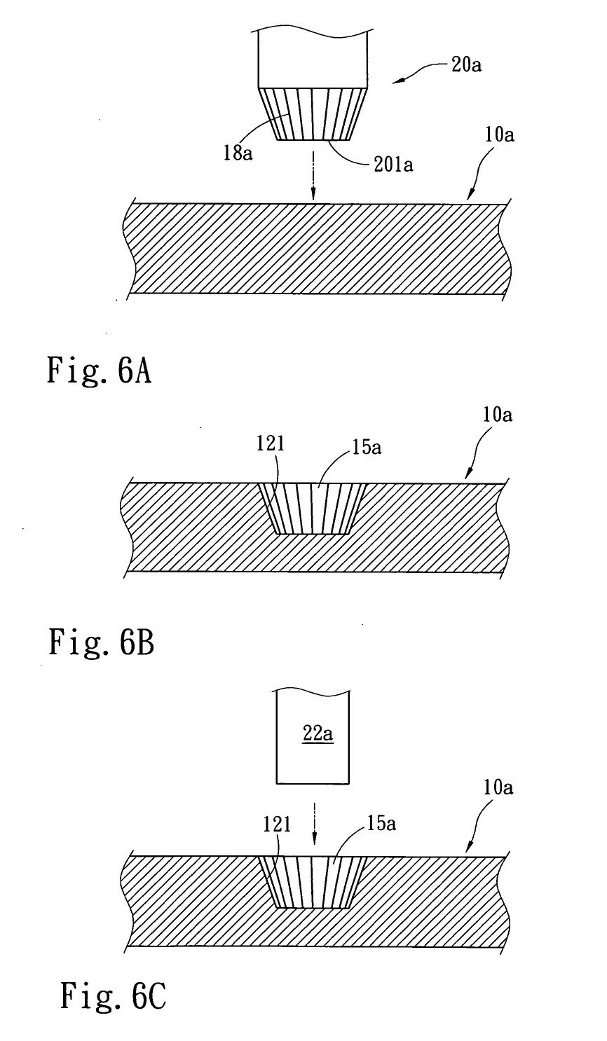

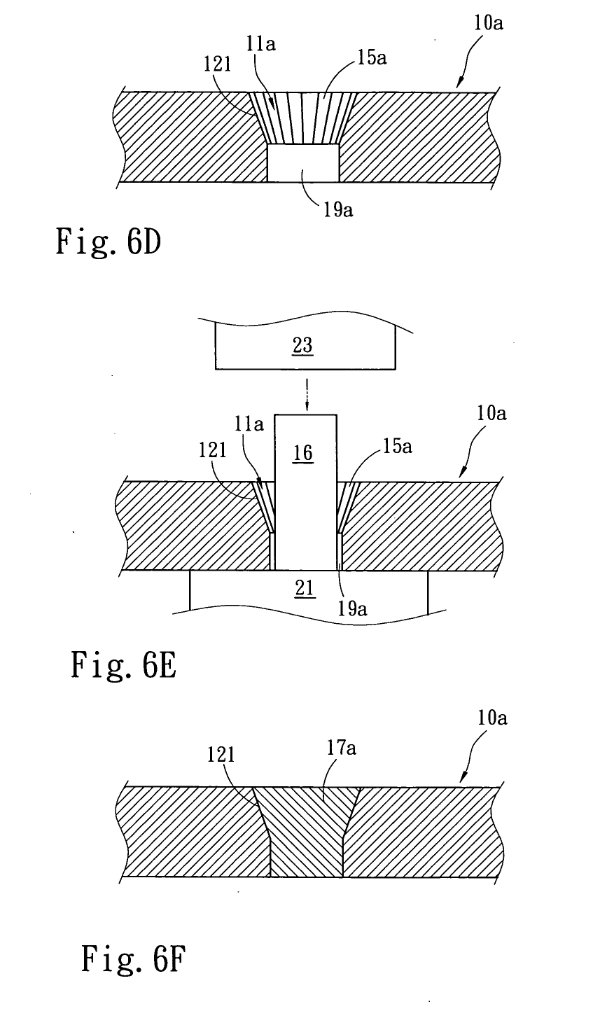

Refer to FIGS. 4, 5, 6A through 6F for a second embodiment of the silver contact 17a of the invention. The conductive blade 10a is substantially constructed as the first embodiment. However, the first fixing zone 15a is formed in a saw shape. The process for fabricating the silver contact 17a includes the following steps in the order of A: stamping a blank; B: stamping the blank for a second time; and C: planting the silver wire.

Step A: stamping a blank. Form the first fixing zone 15a on the conductive blade 10a by stamping through a first upper mold 20a. The punching end 201a of the first upper mold 20a has an extended angle 18a with a lower tapered end formed in a saw shape.

Step B: stamping the blank for a second time through a second upper mold 22a smaller than the first upper mold 20a to form a second fixing zone 19a on the conductive blade 10a that is smaller than the first fixing zone 15a. The second upper mold 22a is a cylinder.

Step C: planting the silver wire. Place the conductive blade 10a on a first lower mold 21; place the silver wire 16 in the fastening section 11a which consists of the first fixing zone 15a and the second fixing zone 19a; press and fill the silver wire 16 in the fastening section 11a through a third upper mold 23 to finish the fabrication of the silver contact 17a of the second embodiment. The first fixing zone 15 has a bucking end 121 formed on the peripheral side of one end in a chamfered angle.

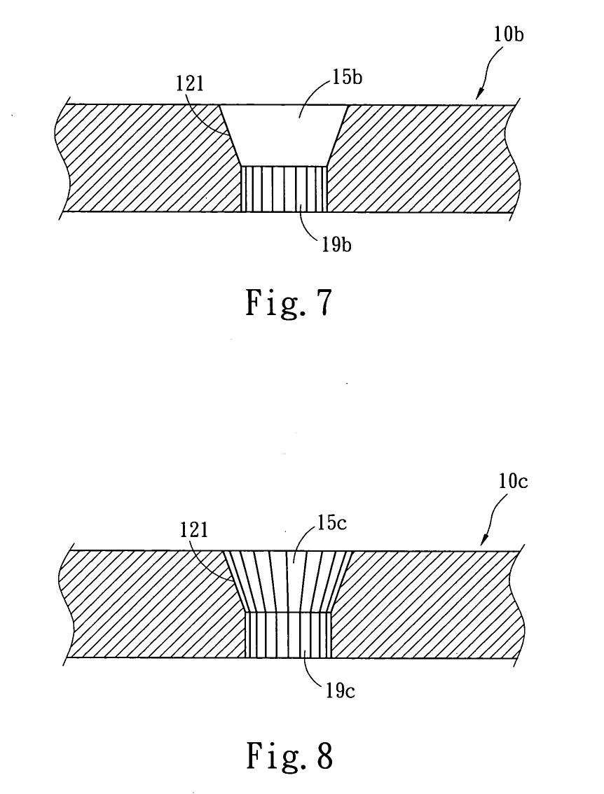

Refer to FIGS. 7 and 8 for the conductive blades 10b and 10c of a third and a fourth embodiment of the invention. They are formed in a shape substantially similar to the second embodiment. The fabrication step A for stamping a blank and the step B for stamping the blank for a second time and the step C for planting the silver wire (not shown in the drawings) set forth above are also applied. However, in the third embodiment, the first fixing zone 15b is a conical trough with a tapered lower end and the second fixing zone 19b is a circular trough with a saw type inner wall. In the fourth embodiment, the first and the second fixing zones 15c and 19c are formed in a saw type, and the first fixing zone 15c is a conical trough with a tapered lower end.

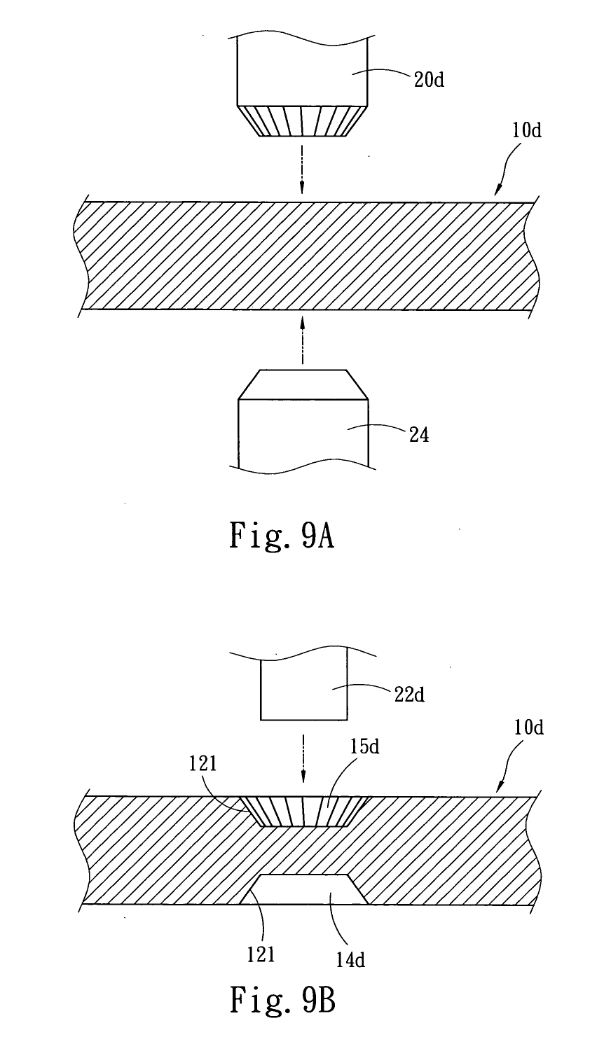

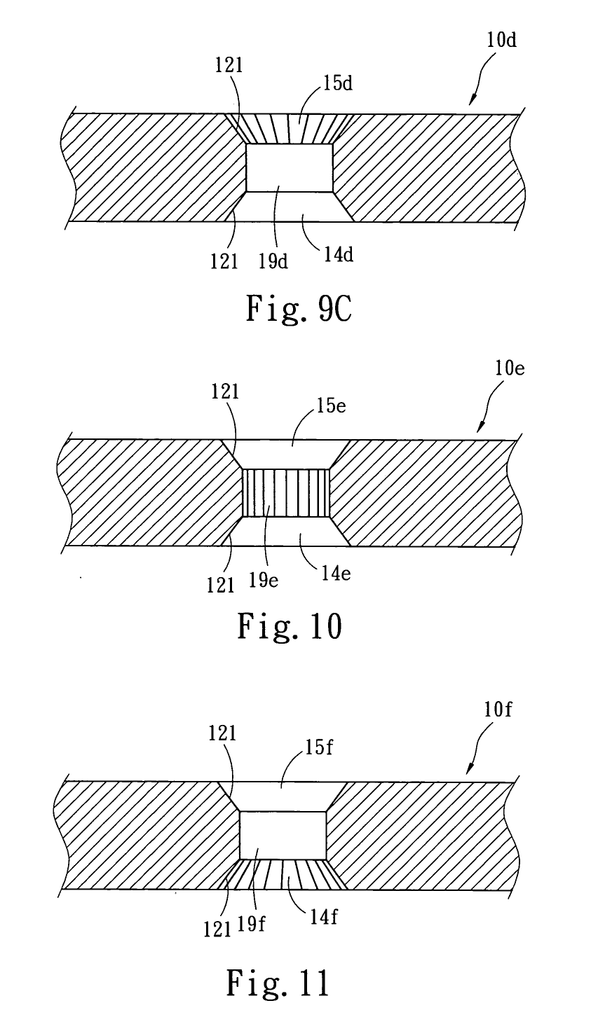

Refer to FIGS. 9A, 9B, 9C and 13 for a fifth embodiment of the invention. The fastening section includes first, second and third fixing zones 15d, 19d and 14d. The fabrication process includes A: stamping a blank; B: stamping the blank for a second time; and C: planting the silver wire.

Step A: stamping a blank. A first upper mold 20d and a second lower mold 24 are used to stamp a conductive blade 10d on the upper side and the lower side to form the first and third fixing zones 15d and 14d.

Step B: stamping the blank for a second time. From a second fixing zone 19d on the conductive blade 10d through a second upper mold 22d that is smaller than the first and third fixing zones 15d and 14d. The first and the third fixing zones 15d and 14d are conical troughs with a tapered end adjacent to the horizontal center of the conductive blade 10d. The first fixing zone 15d also has a saw type peripheral wall.

Step C: planting the silver wire (not shown in the drawings). The silver wire is placed in a fastening section 11d formed by the first, second and third fixing zones 15d, 19d and 14d, and is pressed and filled in the fastening section 11d through a third upper mold (not shown in the drawings).

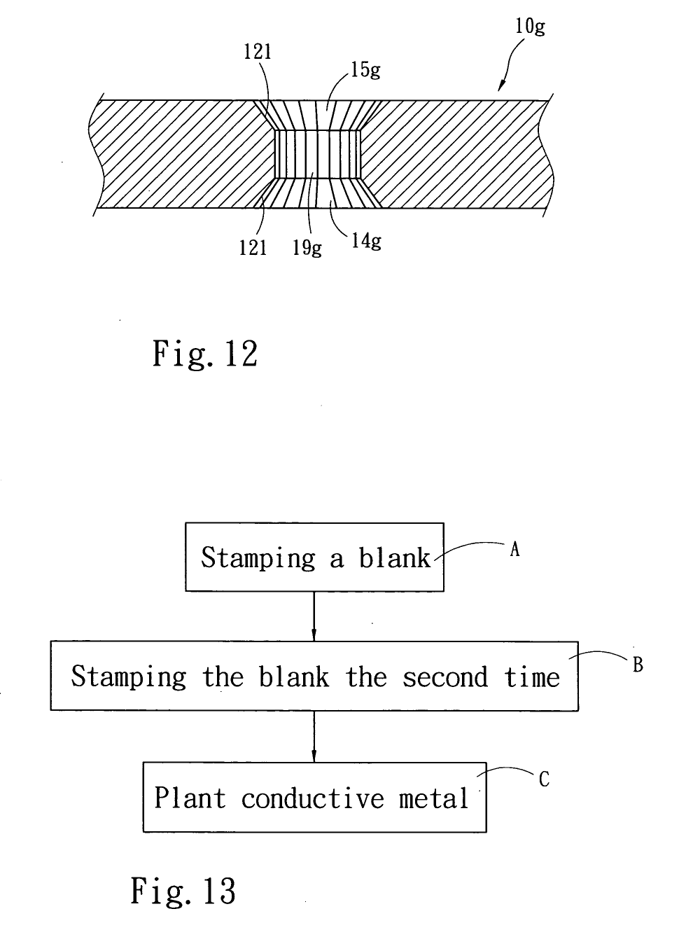

Refer to FIGS. 10, 11 and 12 for a sixth embodiment (FIG. 10), seventh embodiment (FIG. 11) and eighth embodiment (FIG. 12). The fabrication processes are substantially the same as those previously discussed. The sixth embodiment includes a first, second and third fixing zone 15e, 19e and 14e. Only the second fixing zone 19e (FIG. 10) is formed in a saw type. The seventh embodiment includes a first, second and third fixing zone 15f, 19f and 14f. Only the third fixing zone 14f (FIG. 11) is formed in a saw type. The eighth embodiment (FIG. 12) includes a first, second and third fixing zone 15g, 19g and 14g, and all of them are formed in a saw type.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments that do not depart from the spirit and scope of the invention.

1. A silver contact fixing structure for conductive blades comprising a conductive blade which has a fastening section for holding a silver contact;
wherein the fastening section has a first fixing zone and a second fixing zone on a vertical surface corresponding to the conductive blade that connects to each other, the first fixing zone being greater than the second fixing zone and forming a bucking end on the juncture of the first fixing zone and the second fixing zone, a silver wire being pressed and filled in the fastening section to form a silver contact which is shaped as the fastening section to be retained by the bucking end to form a strengthened fixing.

2. The silver contact fixing structure of claim 1, wherein the silver contact structure is formed by a fabrication method which comprises steps of:
A. stamping a blank by stamping the conductive blade through a first upper mold to form the first fixing zone;
B. stamping the blank for a second time by stamping the conductive blade through a second upper mold which is smaller than the first upper mold to form the second fixing zone which is smaller than the first fixing zone; and
C. planting the silver wire by placing the conductive blade on a first lower mold, and placing the silver wire in the fastening section formed by the first fixing zone and the second fixing zone, and pressing and filling the silver wire in the fastening section through a third upper mold.

3. The silver contact fixing structure of claim 1, wherein the fastening section includes a third fixing zone on a surface opposing the first fixing zone and adjacent to the second fixing zone, the third fixing zone being larger than the second fixing zone to form another bucking end on the juncture of the third fixing zone and the second fixing zone.

4. The silver contact fixing structure of claim 1, wherein the horizontal cross sections of the first fixing zone and the second fixing zone are non-circular.

5. The silver contact fixing structure of claim 2, wherein the horizontal cross section of the first fixing zone is non-circular.

6. The silver contact fixing structure of claim 2, wherein the horizontal cross section of the second fixing zone is non-circular.

7. The silver contact fixing structure of claim 2, wherein the horizontal cross sections of the first fixing zone and the second fixing zone are non-circular.

8. The silver contact fixing structure of claim 2, wherein the fastening section includes a third fixing zone on a surface opposing the first fixing zone and adjacent to the second fixing zone, the third fixing zone being larger than the second fixing zone to form another bucking end at the juncture of the third fixing zone and the second fixing zone.

9. The silver contact fixing structure of claim 1, wherein the silver contact structure is formed by a fabrication method which comprises steps of:
A. stamping a blank by stamping the conductive blade through a first upper mold and a third upper mold to form the first fixing zone and a third fixing zone on the stamping blade;
B. stamping the blank for a second time by stamping the conductive blade through a second upper mold that is smaller than the first upper mold and the third upper mold to form the second fixing zone that is smaller than the first fixing zone and the third fixing zone; and
C. planting the silver wire by placing the conductive blade on a first lower mold, and placing the silver wire in the fastening section formed by the first fixing zone, the second fixing zone and the third fixing zone, and pressing and filling the silver wire in the fastening section through a third upper mold.

10. The silver contact fixing structure of claim 9, wherein the horizontal cross section of the first fixing zone is non-circular.

11. The silver contact fixing structure of claim 9, wherein the horizontal cross section of the second fixing zone is non-circular.

12. The silver contact fixing structure of claim 9, wherein the horizontal cross section of the third fixing zone is non-circular.

13. The silver contact fixing structure of claim 9, wherein the horizontal cross sections of the first fixing zone, the second fixing zone, and the third fixing zone are non-circular.
